(19) United States
(12) Patent Application Publication
(10) Pub. No.: US 2012/0274439 A1
(43) Pub. Date: Nov. 1, 2012

(54) Device for Electrical Isolation and Toroidal Core Choke

(75) Inventor: Guenter Feist, Gingen/Fils (DE)

(73) Assignee: EPCOS AG, Muenchen (DE)

(21) Appl. No.: 13/509,485

(22) PCT Filed: Nov. 18, 2010
(86) PCT No.: PCT/EP2010/067759

§ 371 Date: Jul. 12, 2012

(30) Foreign Application Priority Data
Nov. 19, 2009 (DE) 10 2009 054 001.6

(51) Int. Cl. H01F 27/28; H01F 41/00

(52) U.S. Cl. 336/229; 427/97.1; 427/97.4

(57) ABSTRACT

A metallization can be used for components working with acoustic waves. The metallization includes a base having a bottom layer comprising titanium, and an upper layer comprising copper. A top layer of the metallization disposed on the base comprises aluminum.

This patent application is a national phase filing under section 371 of PCT/EP2010/067759, filed Nov. 18, 2010, which claims the priority of German patent application no. 10 2009 054 001.6, filed Nov. 19, 2009, each of which is incorporated herein by reference in its entirety.

### TECHNICAL FIELD

The invention relates to a device for electrical isolation to be installed in a core hole of a toroidal core. The application relates, furthermore, to a toroidal core choke which has a toroidal core, a device for electrical isolation and at least two windings isolated from one another electrically by the device.

### BACKGROUND

Toroidal core chokes with windings arranged on a toroidal core are commonly known. With regard to toroidal core chokes having a plurality of windings, there is in this case the fundamental problem of separating the individual windings from one another electrically.

An approach is to insulate the wires of individual windings electrically. However, this is relatively costly and leads to an increase in the space requirement.

European patent publication EP 1797572 B1 discloses a device for electrical isolation, a toroidal core choke and a method for producing a toroidal core choke. The device for electrical isolation described there comprises a middle part and three elastically deformable webs which run outward and can be wound around the middle part and which have a rigid insulating region in each case at their end facing away from the middle part. By the middle part being rotated with respect to the insulating regions, a device is adapted to the inside diameter of different toroidal cores.

In the known device, at least three webs are required for correctly positioning and securing the device. It is therefore unsuitable, in particular, for toroidal core chokes with only two windings, such as are commonly employed particularly when used in line filters.

### SUMMARY

In one aspect, the present invention discloses a simple-to-produce and simple-to-mount device for electrical isolation to be installed in a core hole of a toroidal core, where the device is to be suitable for compensating tolerances in the diameter of the core hole of the toroidal core. The device is preferably also to be suitable for the stable installation in the core hole of a toroidal core having only two windings.

The following summary of refinements and detailed description of exemplary embodiments employ a cylindrical reference system to designate the different directions. In this case, the direction from the center point of a core hole toward the circumference of a toroidal core is designated as radial, the direction of the rotational axis of symmetry of the toroidal core is designated as axial, and the direction orthogonal at any point to these two directions is designated as tangential.

The device has a central region and two insulating regions projecting out of the central region in the radial direction of the core hole and movable in the radial direction. The central region has a compression zone with at least two mutually parallel first portions of two webs which couple the two insulating regions to one another mechanically. Each of the at least two first portions is deformable elastically in an S-shaped manner, the at least two first portions of the two webs being arranged parallel to one another in the expanded state of the compression zone.

Through the use of parallel first portions deformable elastically in an S-shaped manner, a radial movement of the insulating regions can be converted into a deformation of the two first portions in the region of the compression zone. The two webs which couple the two insulating regions to one another mechanically thereby cause the compression zone to be compressed in the radial direction. A device of this type can thus compensate any tolerances in the inside diameter of the toroidal core.

According to an advantageous refinement, each of the two webs has, furthermore, in each case a second portion, the at least two first portions and the two second portions of the two webs forming the sides of a parallelogram in the expanded state of the compression zone. Such a rhomboid, preferably arranged centrally, makes it possible to compress the compression zone in a kink-free manner.

According to a further advantageous refinement, the at least two first portions have a smaller material thickness than the second portions, so that, in the event of movement of the insulating regions in the radial direction, the at least two first portions are deformed in a S-shaped manner and the second portions are displaced essentially parallel to one another. The refinement described causes the compression zone to be compressed asymmetrically, thus ensuring reliable guidance of the movement of the insulating regions of the device in the radial direction.

According to an advantageous refinement, the device is formed in one piece. It can therefore be produced especially simply and cost-effectively as an injection molding.

According to a further advantageous refinement, the device has two insulating regions lying opposite one another with respect to the central region, so that the device is in the form of a longitudinally compressible web. A configuration of the device in the form of a longitudinally compressible separating web with two insulating regions lying opposite one another is suitable especially for use in toroidal core chokes with two windings, for example for a line filter with a phase conductor and with a neutral conductor.

According to a further advantageous refinement, the insulating regions project beyond a part, connected thereto, of the central region in the tangential direction of the core hole. A desired insulating distance between adjacent windings of the toroidal core can thereby be set independently of the material thickness of the device for electrical isolation in the central region.

According to a further refinement, the insulating regions have in each case a cavity. The use of a cavity makes it possible to save material during the forming of insulating regions having a relatively long insulating distance.

According to a further advantageous refinement, the device has at least one holding part with at least one latching element for latching the device to a holder for receiving the toroidal core choke. A holding part of this type makes it possible to latch the toroidal core choke on a circuit board or in a similar arrangement for mechanically fixing the toroidal core choke.

According to a further refinement, the end faces, confronting the toroidal core, of the insulating regions have nose-shaped projections for latching the toroidal core into the device. Latching the toroidal core between nose-shape projections of an end face makes it possible to fasten the device in the toroidal core securely and without any adhesive.

Aspects of the invention also provide a toroidal core choke having a toroidal core, a device for electrical isolation according to one of the abovementioned refinements and at least two windings insulated from one another electrically by the device for electrical isolation. The central region of the device for electrical isolation is tensioned by the compression zone being compressed and exerts an elastic force upon the two insulating regions in the radial direction of the toroidal core. By the device for electrical isolation being pretensioned by the compression zone being compressed, effective tolerance compensation in terms of the inside diameter of the toroidal core can be achieved.

Further advantageous refinements are given in the following detailed description of exemplary embodiments.

### BRIEF DESCRIPTION OF THE DRAWINGS

The invention is explained in more detail below by means of exemplary embodiments and accompanying figures. The figures show diagrammatic illustrations, not true to scale, of various exemplary embodiments.

In these figures:

FIG. 1 shows a front view of a toroidal core choke according to a first exemplary embodiment of the invention;

FIG. 2 shows a perspective illustration of the toroidal core choke according to FIG. 1;

FIGS. 3A and 3B show front views of a device for electrical isolation according to the first exemplary embodiment in the expanded and the compressed state respectively;

FIG. 4 shows a side view of the device for electrical isolation according to FIG. 3B; and

FIG. 5 shows a side view of a device for electrical isolation according to a second exemplary embodiment.

The following list of reference symbols can be used in conjunction with the drawings:

1 Toroidal core choke

2 Toroidal core

3 Winding

4 Device for electrical isolation

5 Core hole

6 Insulating region

7 Central region

8 Holding part

9 Compression zone

10 Web

11 First portion

12 Second portion

13 Cavity

14 Latching element

15 Projection

### DETAILED DESCRIPTION OF ILLUSTRATIVE EMBODIMENTS

FIG. 1 shows a front view of a toroidal core choke toward the plane spanned by the toroidal core of the choke.

The toroidal core choke 1 comprises a toroidal core 2 and two windings 3a and 3b insulated electrically from one another. The windings 3a and 3b are, for example, choke coils in a network supply line for a single-phase power supply network with a phase conductor and with a neutral conductor.

In order to insulate the windings 3a and 3b from one another electrically, the toroidal core choke 1 comprises, furthermore, a device 4 for electrical isolation. The device 4 is fitted into the core hole 5 of the toroidal core 2.

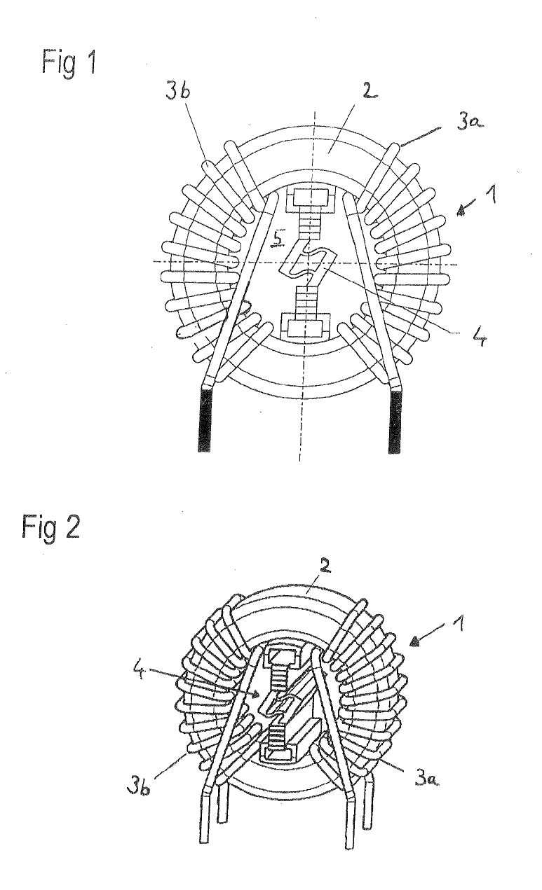

FIG. 2 shows a perspective view of the toroidal core choke 1 according to FIG. 1. The exemplary embodiment is a toroidal core choke 1 to be mounted upright on a printed circuit board. The device 4 for electrical isolation described below is, of course, also suitable for the use with other forms of construction of toroidal core choke 1, in particular also for mounting horizontally.

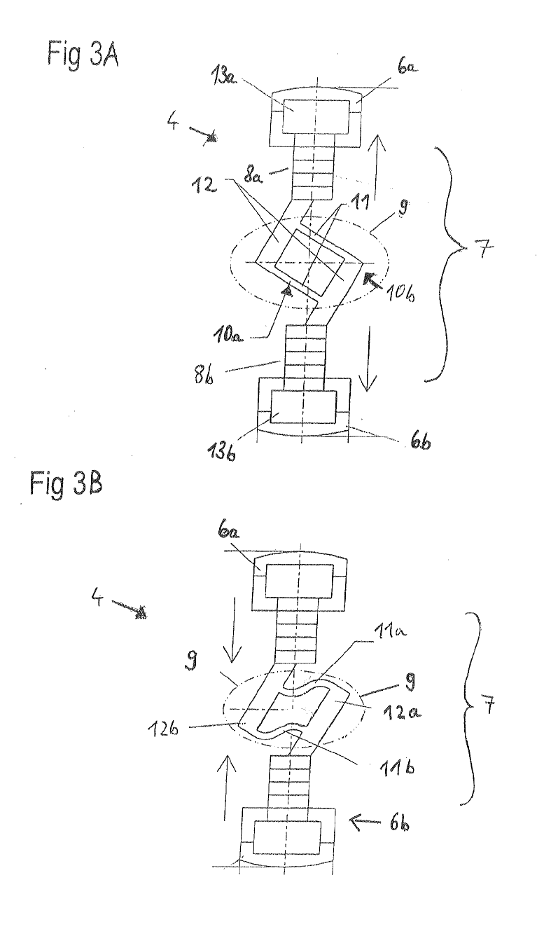

FIGS. 3A and 3B show detailed front views of the device 4 for electrical isolation according to the first exemplary embodiment in the expanded and the compressed state respectively.

The device 4 comprises in each case two insulating regions 6a and 6b respectively at the upper end or the lower end of the device 4 of a web-shaped design. The insulating regions 6a and 6b are connected to one another by means of a central region 7. In the exemplary embodiment illustrated, the central region 7 comprises in each case a holding part 8a and 8b, which respectively adjoin the insulating regions 6a and 6b, and a central compression zone 9 arranged between the holding parts 8a and 8b. The compression zone 9 can be compressed in the radial direction of the toroidal core choke 1, that is to say in the vertical direction in FIG. 3A.

For this purpose, the compression zone 9 illustrated in FIGS. 3A and 3B has two webs 10a and 10b. Each of the webs 10a and 10b respectively has a first portion 11a and 11b and a second portion 12a and 12b. The webs 10a and 10b are composed of an elastic material and can therefore be deformed under the action of force.

In the exemplary embodiment, the entire device 4 is produced as a one-piece plastic injection molding. The material used is preferably a heat-resistant and low-flammability plastic.

The webs 10a and 10b, in the state in which they are installed in the device 4, are configured point-symmetrically with respect to the center point of the device 4 and the center point of the core hole 5. Their portions 11a, 11b, 12a and 12b enclose a cavity in the projection illustrated and form a parallelogram in the expanded state illustrated in FIG. 3A. In this case, the first portions 11a and 11b have a smaller material thickness than the second material portions 12a and 12b. Consequently, the first portions 11a and 11b can be deformed elastically more easily than the second portions 12a and 12b.

By the insulating regions 6a and 6b being pressed together, for example, when the device 4 is inserted into a toroidal core 2, the central region 7 is compressed. Compression of the central region 7 in this case leads to deformation of the webs 10a and 10b, as illustrated in FIG. 3B. In this case, the first portions l la and 1 lb of the webs 10a and 10b are deformed in an S-shaped manner. The second portions 12a and 12b are displaced in relation to one another in the direction of the radial axis. However, at the same time, they remain largely dimensionally stable.

To increase the spring action exerted by the compression zone 9, in a further embodiment, not illustrated, further first portions 11 deformable in an S-shaped manner are arranged between the second portions 12.

The compression illustrated in FIG. 3B has the advantage that radial compression of the insulating regions 6a and 6b leads to parallel displacement of the longitudinal axes in the region of the holding parts 8a and 8b, so that movement of the insulating regions 6a and 6b takes place predominantly in the radial direction. In particular, the central region 7 does not collapse laterally. Together with the outwardly acting force generated by the compression zone 9, this makes it possible for the device 4 having only two insulation regions 6 to be seated firmly in a toroidal core 2 of a toroidal core choke 1.

As illustrated in FIGS. 3A and 3B, the insulating regions 6 project in the tangential direction beyond the holding parts 8 of the central region 7 and thus provide a desired insulating distance between the adjacent windings 3a and 3b. In order nevertheless to make it possible to produce a device 4 simply, and so as to save material, by means of an injection molding method, the insulating regions 6a and 6b in the exemplary embodiment illustrated in each case have a cavity 13a and 13b.

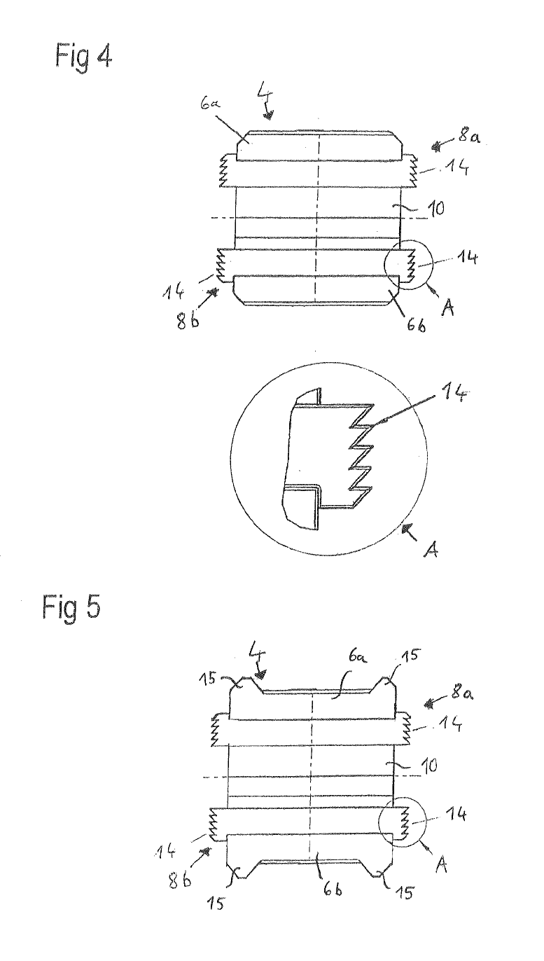

FIG. 4 shows a side view of the device 4 toward the plane spanned by the axial and radial direction.

It can be seen in FIG. 4 that, in the exemplary embodiment, the holding parts 8 are configured on both sides with latching elements 14. The latching elements 14 in this case make it possible to latch the device 4 securely together with an essentially U-shaped holder, not illustrated in the figures, for receiving the toroidal core choke 1 on a circuit board. The latching elements 14 of the region A are illustrated enlarged in the lower part of FIG. 4.

FIG. 5 shows a side view of a device 4 according to a second exemplary embodiment. The side view according to FIG. 5 also shows the plane spanned by the axial and radial direction of a toroidal core 2.

It can be seen in FIG. 5 that the insulating regions 6a and 6b according to the second exemplary embodiment have on their end faces in each case two nose-shaped projections 15 which mesh the device 4 in the inserted state together with the toroidal core 2, not illustrated in FIG. 5. In this case, the compression zone 9 exerts an elastic force upon the end faces of the insulating regions 6, which causes the toroidal core 2 to be latched into the depressions between the projections 15 and makes separate fastening, such as, for example, adhesive bonding, of the device 4 to the toroidal core 2 unnecessary.

The invention is not restricted to the exemplary embodiments illustrated in the figures and described in detail above. In particular, the configuration and number of the insulating regions can be adapted to the requirements of toroidal core chokes having different windings.

1-20. (canceled)

21. A metallization for carrying current in an electrical component, the metallization comprising:
a bottom layer overlying a substrate surface and comprising Ti or a titanium compound as main constituent;
an upper layer overlying the bottom layer and comprising Cu as main constituent, wherein the bottom layer and the upper layer form a base layer; and
a top layer in direct contact with the upper layer and comprising Al as main constituent.

22. The metallization according to claim 21, wherein in the base layer further comprises a middle layer that is arranged between the bottom layer and the upper layer, the middle layer comprising an element that is nobler than Al.

23. The metallization according to claim 21, wherein the bottom layer is thinner than the upper layer.

24. The metallization according to claim 21, wherein the upper layer is thinner than the top layer.

25. The metallization according to claim 22, wherein the middle layer is thinner than the bottom layer or thinner than the upper layer.

26. The metallization according to claim 22, wherein the bottom layer has a thickness of between 2 nm and 20 nm, the middle layer has a thickness of between 0.5 nm and 10 nm, and the upper layer has a thickness of between 1 nm and 30 nm.

27. The metallization according to claim 21, wherein the bottom layer comprises TiN.

28. The metallization according to claim 22, wherein the middle layer comprises Ag, Au, Pt or Pd.

29. The metallization according to claim 22, wherein the middle layer consists of Ag.

30. The metallization according to claim 21, wherein Al is the main constituent of the top layer, and the top layer comprises Cu, Mg, an Al—Cu alloy, an Al—Mg alloy or an Al—Cu—Mg alloy.

31. The metallization according to claim 21, wherein the top layer has a <1 1 1>texture.

32. The metallization according to claim 21, wherein the top layer has a twin texture or a single texture.

33. The metallization according to claim 21, further comprising a piezoelectric layer arranged between the substrate and the bottom layer.

34. The metallization according to claim 33, wherein the piezoelectric layer comprises LiTaO₃ or LiNbO₃.

35. The metallization according to claim 21, wherein the substrate is piezoelectric.

36. The metallization according to claim 35, wherein the substrate comprises LiTaO₃ or LiNbO₃.

37. A method for producing an electrical component, the method comprising:
providing a substrate;
applying a metallization using a lift-off technique; the metallization comprising:
a bottom layer overlying a surface of the substrate and comprising Ti or a titanium compound as main constituent;
an upper layer overlying the bottom layer and comprising Cu as main constituent; and
a top layer in direct contact with the upper layer and comprising Al as main constituent.

38. The method according to claim 37, the method comprising:
cleaning the surface of the substrate;
applying photoresist to the surface of the substrate;
patterning the photoresist;
applying the metallization to uncovered surfaces of substrate and to the photoresist; and
lifting-off the photoresist together with regions of metallization applied to the photoresist.

39. A component comprising:
a piezoelectric layer;
a bottom layer overlying the piezoelectric layer and comprising Ti or a titanium compound as main constituent;
an upper layer overlying the bottom layer and comprising Cu as main constituent, wherein the bottom layer and the upper layer form a base layer; and
a top layer in direct contact with the upper layer and comprising Al as main constituent;
wherein the component is configured to operate with acoustic waves.

40. The component according to claim 39, wherein the component is configured to operate with surface acoustic waves.

41. The component according to claim 40, wherein the component comprises a duplexer operating with surface acoustic waves.
